(19) United States
(12) Patent Application Publication
(10) Pub. No.: US 2017/0236119 A1
(43) Pub. Date: Aug. 17, 2017

(54) SYSTEM AND METHOD FOR IMPLEMENTING MULTI-RATE CURRENCY ASPECTS OF MULTI-BOOK ACCOUNTING

(71) Applicant: NETSUITE INC., SAN MATEO, CA (US)

(72) Inventors: MICHAL KAMENSKY, PRUSANKY (CZ); MICHAEL YE, FOSTER CITY, CA (US); STEPHEN CLODE, SAN JOSE, CA (US)

(21) Appl. No.: 15/414,274

(22) Filed: Jan. 24, 2017

Related U.S. Application Data
(60) Provisional application No. 62/286,813, filed on Jan. 25, 2016.

(51) Int. Cl. G06Q 20/38

(52) U.S. Cl. CPC G06Q 20/381

(57) ABSTRACT

A multi-book accounting system capable of immediately updating all secondary books regardless of underlying currency when transactions are entered in the primary book with respect to consolidation and elimination aspects. This may be accomplished by using a consolidated exchange rate database that can serve as a basis for currency exchange rates for any book in a multi-book setting. Thus, users will be able to run consolidated reports via a multi-tenant online accounting service. Consolidated impact of any transaction will be calculated automatically when any consolidated report in any secondary book is invoked similar to the process with respect to any primary book. A separate set of consolidated exchange rates may be applied in the various secondary accounting books. Furthermore, users will be able to run automatic intercompany elimination via a multi-tenant online accounting service for secondary books in the same way as it is possible for primary accounting book.

### PRIORITY CLAIM

This application claims the benefit of U.S. Provisional Application No. 62/286,813, entitled “System and Method for Implementing Multi-Rate Currency Aspects of Multi-Book Accounting,” filed Jan. 25, 2016, which is incorporated by reference in its entirety herein for all purposes.

### BACKGROUND

In a distributed computing, multi-tenant platform, several differing factors may affect various tenants across various applications executing within the platform. Further, as individual tenants choose to alter or change manners in which specific applications functions, disparities between “the way it is now” and “the way it used to be” present at various times. This is particularly problematic for users who keep multiple sets of books for a variety of reasons. Thus, secondary books may be kept for internal reasons (such as a set of books for US transaction in US dollars and a set of books for European transaction in Euros) that include some representations of the same transactions as a primary book but expressed and accounted for in distinctive ways.

As multi-book accounting is implemented, various errors in data processing may occur because of varying rules across varying start dates for the various books. Thus, a tenant using an accounting system in a multi-tenant platform may wish to detect, identify and address data processing errors occurring within a single tenant's account. This presents questions on how to provide an extended functionality to a data processing application for a subset of the tenants of a multi-tenant platform, how to provide data security for a multi-tenant platform without exposing any tenant's data to corruption, how to provide the capability for data sharing between tenants of a multi-tenant platform. In conventional systems, tenants are not able to run financial consolidation in any secondary accounting books. That is, any consolidation performed in a primary book does not also post to secondary books. Further, conventional systems do not allow customers to eliminate intercompany transactions in such secondary accounting books. These tasks time consuming and error prone because of the manual nature of the consolidation and elimination. The problems are also particularly difficult to address across different accounting books in a multi-book setting when one or more secondary books are kept using a differing currency. Thus, exchange rates used in a primary may be different than exchange rates used in secondary books.

### BRIEF DESCRIPTION OF THE DRAWINGS

Aspects and many of the attendant advantages of the claims will become more readily appreciated as the same become better understood by reference to the following detailed description, when taken in conjunction with the accompanying drawings, wherein:

FIG. 1 is a diagram illustrating elements or components of an example operating environment in which an embodiment of the subject matter disclosed herein may be implemented;

FIG. 2 is a diagram illustrating additional details of the elements or components of the multi-tenant distributed computing service platform of FIG. 1, in which an embodiment of the subject matter disclosed herein may be implemented;

FIG. 3 is a diagram illustrating a simplified system of FIG. 1, including an integrated business system and an enterprise network in which an embodiment of the subject matter disclosed herein may be implemented;

FIG. 4 is a block diagram of a system for consolidating multiple rate currencies associated with different corporate entities according to an embodiment of the subject matter disclosed herein;

FIG. 5 is a block diagram showing a high-level view of a system for consolidating multiple rate currencies associated with different corporate entities according to an embodiment of the subject matter disclosed herein;

FIG. 6 is a block diagram showing a detailed view of a system for consolidating multiple rate currencies associated with different corporate entities according to an embodiment of the subject matter disclosed herein;

FIG. 7 is a data flow diagram showing a high level view a consolidation action across a primary book and a secondary book using different currency exchange rates according to an embodiment of the subject matter disclosed herein;

FIG. 8 is a data flow diagram showing a high level view an elimination action across a primary book and a secondary book using different currency exchange rates according to an embodiment of the subject matter disclosed herein;

FIG. 9 is a data flow diagram illustrating a method for maintaining consistency when consolidating multiple rate currencies across multiple books in accordance with an embodiment of the subject matter disclosed herein; and

FIG. 10 is a diagram illustrating elements or components that may be present in a computer device or system configured to implement a method, process, function, or operation in accordance with an embodiment of the subject matter disclosed herein.

Note that the same numbers are used throughout the disclosure and figures to reference like components and features.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Embodiments will be described more fully hereinafter with reference to the accompanying drawings, which form a part hereof, and which show, by way of illustration, exemplary embodiments by which the systems and methods described herein may be practiced. This systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

Among other things, the present subject matter may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, etc.) that are part of a client device, server, network element, or other form of computing or data processing device/platform and that is programmed with a set of executable instructions (e.g., software instructions), where the instructions may be stored in a suitable non-transitory data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

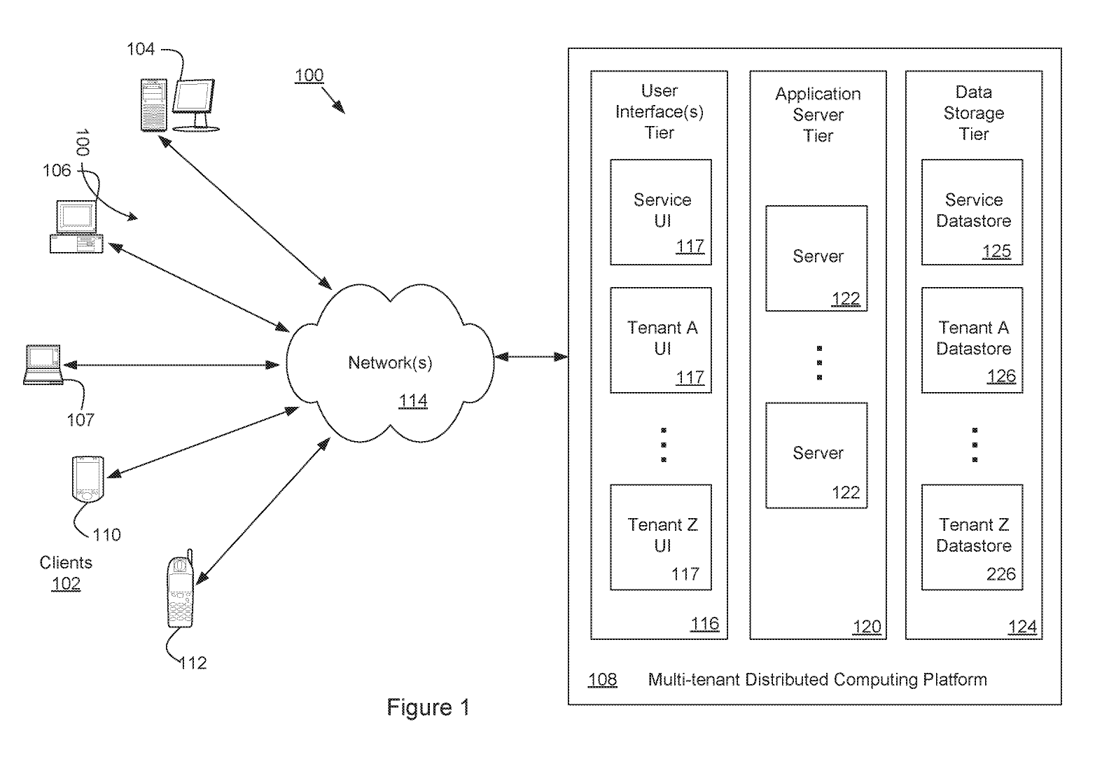

In some embodiments, the subject matter may be implemented in the context of a multi-tenant, “cloud” based environment (such as a multi-tenant business data processing platform), typically used to develop and provide web services and business applications for end users. This exemplary implementation environment will be described with reference to FIGS. 1-10 below. Note that embodiments may also be implemented in the context of other computing or operational environments or systems, such as for an individual business data processing system, a private network used with a plurality of client terminals, a remote or on-site data processing system, another form of client-server architecture, etc.

Modern computer networks incorporate layers of virtualization so that physically remote computers and computer components can be allocated to a particular task and then reallocated when the task is done. Users sometimes speak in terms of computing “clouds” because of the way groups of computers and computing components can form and split responsive to user demand, and because users often never see the computing hardware that ultimately provides the computing services. More recently, different types of computing clouds and cloud services have begun emerging.

For the purposes of this description, cloud services may be divided broadly into “low level” services and “high level” services. Low level cloud services (sometimes called “raw” or “commodity” services) typically provide little more than virtual versions of a newly purchased physical computer system: virtual disk storage space, virtual processing power, an operating system, and perhaps a database such as an RDBMS. In contrast, high or higher level cloud services typically focus on one or more well-defined end user applications, such as business oriented applications. Some high-level cloud services provide an ability to customize and/or extend the functionality of one or more of the end user applications they provide; however, high level cloud services typically do not provide direct access to low level computing functions.

The ability of business users to access crucial business information has been greatly enhanced by the proliferation of IP-based networking together with advances in object oriented Web-based programming and browser technology. Using these advances, systems have been developed that permit web-based access to business information systems, thereby allowing a user with a browser and an Internet or intranet connection to view, enter, or modify business information. For example, substantial efforts have been directed to Enterprise Resource Planning (ERP) systems that integrate the capabilities of several historically separate business computing systems into a common system, with a view toward streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions.

In a related development, substantial efforts have also been directed to integrated Customer Relationship Management (CRM) systems, with a view toward obtaining a better understanding of customers, enhancing service to existing customers, and acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. With differing levels of overlap with ERP/CRM initiatives and with each other, efforts have also been directed toward development of increasingly integrated partner and vendor management systems, as well as web store/eCommerce, product lifecycle management (PLM), and supply chain management (SCM) functionality.

By way of overview, the subject matter disclosed herein may be directed to systems, apparatuses, and methods for identifying and addressing errors that present between secondary books and a primary book in a set of books in multi-book accounting environment when one or more secondary books are kept using a different currency than the primary book. These errors typically present during consolidation or elimination procedures.

Consolidation is the process that transforms individual financial statements for a group of entities into a single financial statement. In the United States, this process creates a consolidated financial statement that is based on U.S. Generally Accepted Accounting Principles (GAAP), the standard that applies to external, or statutory, financial reporting. To create a consolidated financial report, companies that own all or part of other companies create financial reports to meet both internal and external reporting requirements.

In accordance with Financial Accounting Standards Board (FASB) Statement No. 52, if a foreign entity's financial records are not maintained in the functional currency of a parent company, then the financial records must be translated. For example, a U.S. parent company may have a fully-owned foreign subsidiary located in the United Kingdom. The British subsidiary may have a subsidiary in Germany. The German entity's financial records are maintained in euros ( [symbol] ), their functional currency, such that all transactions ultimately have to balance out and be reported legally in euros. However, the functional currencies of British subsidiary and the U.S. parent company are British pounds (£) and U.S. dollars (USD), respectively. Thus, the German branch's financial records kept in euros must be translated into British pounds because the British subsidiary is the immediate parent of the German subsidiary. The value of the German financial are then translated from British pounds to U.S. dollars, which is the presentation currency of the financials at the U.S. parent company level.

A problem that occurs in the consolidation process is managing the different functional currencies used by each entity in the corporate hierarchy. Conventional consolidation is accomplished by exporting summarized financial data from different subsidiaries into an external tool such as a spread sheet application (e.g., Microsoft Excel) or financial analysis and reporting software (e.g., Microsoft FRx). In external consolidation, which typically occurs at the end of the month, financial data from different entities is entered and accounting rules are applied outside of the system to convert to other currencies based on the appropriate exchange rates. This is done for all of the different subsidiaries resulting in a consolidated set of financial data. However, such externally consolidated financial data cannot be performed “on-the-fly” or accessed in real time by higher level entities in the corporate structure. This can be a disadvantage as the ability to produce real-time or pseudo real-time consolidated financial data provides decision makers with the most current information regarding the operations of subsidiaries. Various solutions to these problems are addressed in U.S. Pat. No. 8,622,290 entitled “Multiple Rate Currency Consolidator” issued on Jan. 7, 2014 and assigned to Application, Inc, which is incorporated herein by reference in its entirety for all purposes.

In the novel method and system presented herein, a user of the multi-book accounting system will be able to immediately update all secondary books regardless of underlying currency when transactions are entered in the primary book with respect to consolidation and elimination aspects. This may be accomplished by using a consolidated exchange rate database that can serve as a basis for currency exchange rates for any book in a multi-book setting. Thus, users will be able to run consolidated reports via a multi-tenant online accounting service. Consolidated impact of any transaction will be calculated automatically when any consolidated report in any secondary book is invoked similar to the process with respect to any primary book. A separate set of consolidated exchange rates may be applied in the various secondary accounting books. Furthermore, users will be able to run automatic intercompany elimination via a multi-tenant online accounting service for secondary books in the same way as it is possible for primary accounting book. Inter-company transactions may be identified by system and elimination journal entries may be posted automatically.

The functionality of being able to run consolidated reports for secondary books provides for an automated method and system whereby manual errors are eliminated as currency exchange rates are automated and utilized for assuring multi-book consistency. In turn, this allows users the functionality to check the consolidation impact of every transaction in reports immediately after each transaction is posted. Consolidation is based on consolidation exchange rates which are defined by user, typically generated and stored as separate sets of consolidation exchange rates respectively for every secondary book in a data store for all dedicated exchange rates. These values can be automatically calculated or overwritten by a user manually. Then, based on the impact of individual transactions and based on the consolidated exchange rates, automatic consolidated report for the company may be generated. If done manually, this process would be very time consuming and error prone.

Similarly, the novel system and method may also bring efficiency and accuracy to elimination journal entries across various books in the multi-book accounting setting. In this respect, elimination journal entries are automatically calculated based on the General Ledger impact of the transaction in the particular accounting book and based on the consolidated exchange rate for that accounting book. Again, creation of these journals manually is very complicated and error prone (especially the calculation).

Such a system and method provides several advantages in the context of a multi-tenant platform. First, the systems and method briefly discussed above provide a user with an ability to run regional consolidation using local GAAP rules. For example, a tenant may have a regional HQ in Canada, with multiple subsidiaries in the same country (Canada). Then, to file a tax report in that country, the tenant may need to consolidate the result from multiple subsidiaries in that one country. Further, a tenant may can run consolidated financial statements in both accounting books in cases where companies are obliged to keep two sets of financial results due to transition to new rules, such as the ASU 2014-09 revenue standard. Further yet, a tenant may can run consolidated financial statements across multiple accounting books in more accounting standards. Other objects and advantages of the present invention will be apparent to one of ordinary skill in the art upon review of the detailed description of the present invention and the included figures. Prior to discussing the embodiments, FIGS. 1-3 are presented to show an exemplary computing environment in which one or more embodiments may be practiced and realized.

FIG. 1 is a diagram illustrating elements or components of an example operating environment in which an embodiment may be implemented. In FIG. 1, an example operating environment 100 includes a variety of clients 102 incorporating and/or incorporated into a variety of computing devices that may communicate with a distributed computing service/platform 108 through one or more networks 114. For example, a client may incorporate and/or be incorporated into a client application (e.g., software) implemented at least in part by one or more of the computing devices. Examples of suitable computing devices include personal computers, server computers 104, desktop computers 106, laptop computers 107, notebook computers, tablet computers or personal digital assistants (PDAs) 110, smart phones 112, cell phones, and consumer electronic devices incorporating one or more computing device components, such as one or more electronic processors, microprocessors, central processing units (CPU), or controllers. Examples of suitable networks 114 include networks utilizing wired and/or wireless communication technologies and networks operating in accordance with any suitable networking and/or communication protocol (e.g., the Internet).

The distributed computing service/platform (which may also be referred to as a multi-tenant business-data-processing platform) 108 may include multiple processing tiers, including a user interface tier 116, an application server tier 120, and a data storage tier 124. The user interface tier 116 may maintain multiple user interfaces 117, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, and the like. Each processing tier shown in FIG. 1 may be implemented with a set of computers and/or computer components including computer servers and processors, and may perform various functions, methods, processes, or operations as determined by the execution of a software application or set of instructions. The data storage tier 124 may include one or more data stores, which may include a service data store 125 and one or more tenant data stores 126.

Each tenant data store 126 may contain tenant-specific data that is used as part of providing a range of tenant-specific business services or functions, including but not limited to ERP, CRM, eCommerce, Human Resources management, payroll, and the like. Data stores may be implemented with any suitable data storage technology, including structured query language (SQL) based relational database management systems (RDBMS).

In accordance with one embodiment, the distributed computing service/platform 108 may be a multi-tenant and service platform 108 and may be operated by an entity to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an ERP system that integrates the capabilities of several historically separate business computing systems into a common system, with the intention of streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions. Such functions or business applications are typically implemented by one or more modules of software code/instructions that are maintained on and executed by one or more servers 122 that are part of the platform's Application Server Tier 120.

Another business information system that may be provided as part of an integrated data processing and service platform is an integrated CRM system, which is designed to assist in obtaining a better understanding of customers, enhance service to existing customers, and assist in acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. In addition to ERP and CRM functions, a business information system/platform (such as element 108 of FIG. 1) may also include one or more of an integrated partner and vendor management system, eCommerce system (e.g., a virtual storefront application or platform), product lifecycle management (PLM) system, Human Resources management system (which may include medical/dental insurance administration, payroll, and the like), or supply chain management (SCM) system. Such functions or business applications are typically implemented by one or more modules of software code/instructions that are maintained on and executed by one or more servers 122 that are part of the platform's Application Server Tier 120.

Note that both functional advantages and strategic advantages may be gained using an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform.

The integrated business system shown in FIG. 1 may be hosted on a distributed computing system made up of at least one, but typically multiple, “servers.” A server is a physical computer dedicated to run one or more software services intended to serve the needs of the users of other computers in data communication with the server, for instance via a public network such as the Internet or a private “intranet” network. The server, and the services it provides, may be referred to as the “host” and the remote computers and the software applications running on the remote computers may be referred to as the “clients.” Depending on the computing service that a server offers it could be referred to as a database server, file server, mail server, print server, web server, and the like. A web server is a most often a combination of hardware and the software that helps deliver content (typically by hosting a website) to client web browsers that access the web server via the Internet.

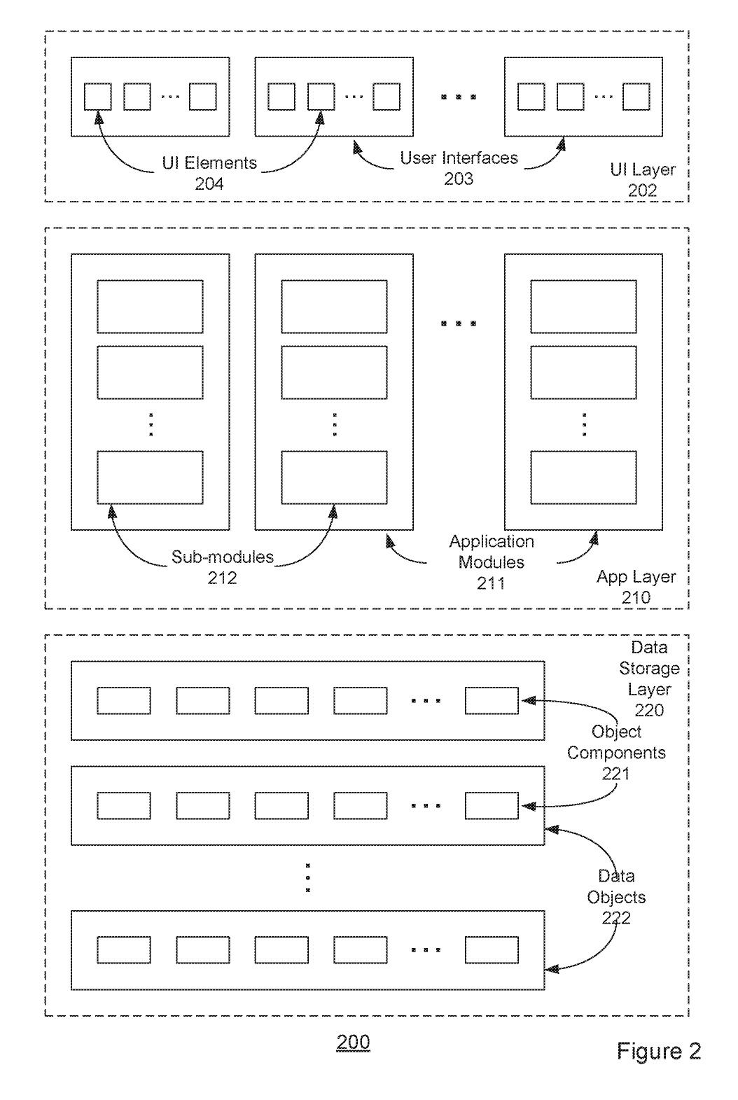

Rather than build and maintain such an integrated business system themselves, a business may utilize systems provided by a third party. Such a third party may implement an integrated business system as described above in the context of a multi-tenant platform, wherein individual instantiations of a single comprehensive integrated business system are provided to a variety of tenants. However, one challenge in such multi-tenant platforms is the ability for each tenant to tailor their instantiation of the integrated business system to their specific business needs. In one embodiment, this limitation may be addressed by abstracting the modifications away from the codebase and instead supporting such increased functionality through custom transactions as part of the application itself. Prior to discussing additional aspects of custom transactions, additional aspects of the various computing systems and platforms are discussed next with respect to FIG. 2.

FIG. 2 is a diagram illustrating additional details of the elements or components of the distributed computing service platform of FIG. 1, in which an embodiment may be implemented. The software architecture depicted in FIG. 2 represents an example of a complex software system to which an embodiment may be applied. In general, an embodiment may be applied to any set of software instructions embodied in one or more non-transitory, computer-readable media that are designed to be executed by a suitably programmed processing element (such as a CPU, microprocessor, processor, controller, computing device, and the like). In a complex system, such instructions are typically arranged into “modules” with each such module performing a specific task, process, function, or operation. The entire set of modules may be controlled or coordinated in their operation by an operating system (OS) or other form of organizational platform.

In FIG. 2, various elements or components 200 of the multi-tenant distributed computing service platform of FIG. 1 are shown, in which an embodiment may be implemented. The example architecture includes a user interface layer or tier 202 having one or more user interfaces 203. Examples of such user interfaces include graphical user interfaces and application programming interfaces (APIs). Each user interface may include one or more interface elements 204. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks and dialog boxes. Application programming interfaces may be local or remote, and may include interface elements such as parameterized procedure calls, programmatic objects and messaging protocols.

The application layer 210 may include one or more application modules 211, each having one or more sub-modules 212. Each application module 211 or sub-module 212 may correspond to a particular function, method, process, or operation that is implemented by the module or sub-module (e.g., a function or process related to providing ERP, CRM, eCommerce or other functionality to a user of the platform). Such function, method, process, or operation may also include those used to implement one or more aspects of the inventive system and methods, such as:
maintain consistency across multiple books in a multi-book accounting environment during consolidation activities even when one or more secondary books are kept is different currencies;
maintain consistency across multiple books in a multi-book accounting environment during elimination activities even when one or more secondary books are kept is different currencies; and
immediately produce impact of newly entered transaction that are consistent across multiple books in a multi-book accounting environment even when one or more secondary books are kept is different currencies.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 122 of FIG. 2) may include each application module. Alternatively, different application servers may include different sets of application modules. Such sets may be disjoint or overlapping.

The data storage layer 220 may include one or more data objects 222 each having one or more data object components 221, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

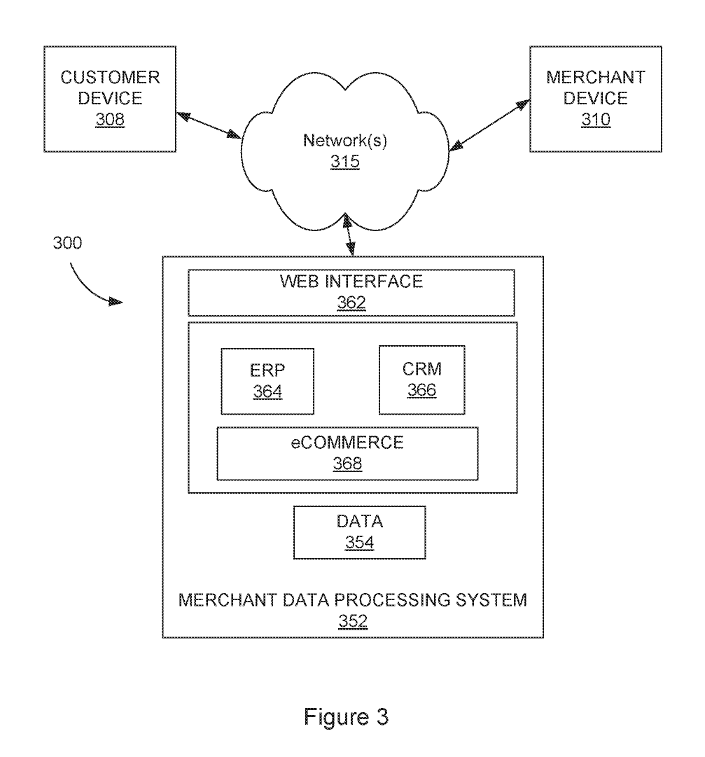

FIG. 3 is a diagram illustrating another perspective of a computing or data processing environment 300 in which an embodiment may be implemented. FIG. 3 illustrates a merchant's data processing system 352, where such a platform or system may be provided to and operated for the merchant by the administrator of a multi-tenant business data processing platform. Thus, the merchant may be a tenant of such a multi-tenant platform, with the elements that are part of system 352 being representative of the elements in the data processing systems available to other tenants. The merchant's data is stored in a data store 354, thereby permitting customers and employees to have access to business data and information via a suitable communication network or networks 315 (e.g., the Internet). Data store 354 may be a secure partition of a larger data store that is shared by other tenants of the overall platform.

A user of the merchant's system 352 may access data, information, and applications (i.e., business related functionality) using a suitable device or apparatus, examples of which include a customer computing device 308 and/or the Merchant's computing device 310. In one embodiment, each such device 308 and 310 may include a client application such as a browser that enables a user of the device to generate requests for information or services that are provided by system 352. System 352 may include a web interface 362 that receives requests from users and enables a user to interact with one or more types of data and applications (such as ERP 364, CRM 366, eCommerce 368, or other applications that provide services and functionality to customers or business employees).

Note that the example computing environments depicted in FIGS. 1-3 are not intended to be limiting examples. Alternatively, or in addition, computing environments in which embodiments may be implemented include any suitable system that permits users to access, process, and utilize data stored in a data storage element (e.g., a database) that can be accessed remotely over a network. Although further examples below may reference the example computing environment depicted in FIGS. 1-3, it will be apparent to one of skill in the art that the examples may be adapted for alternate computing devices, systems, and environments.

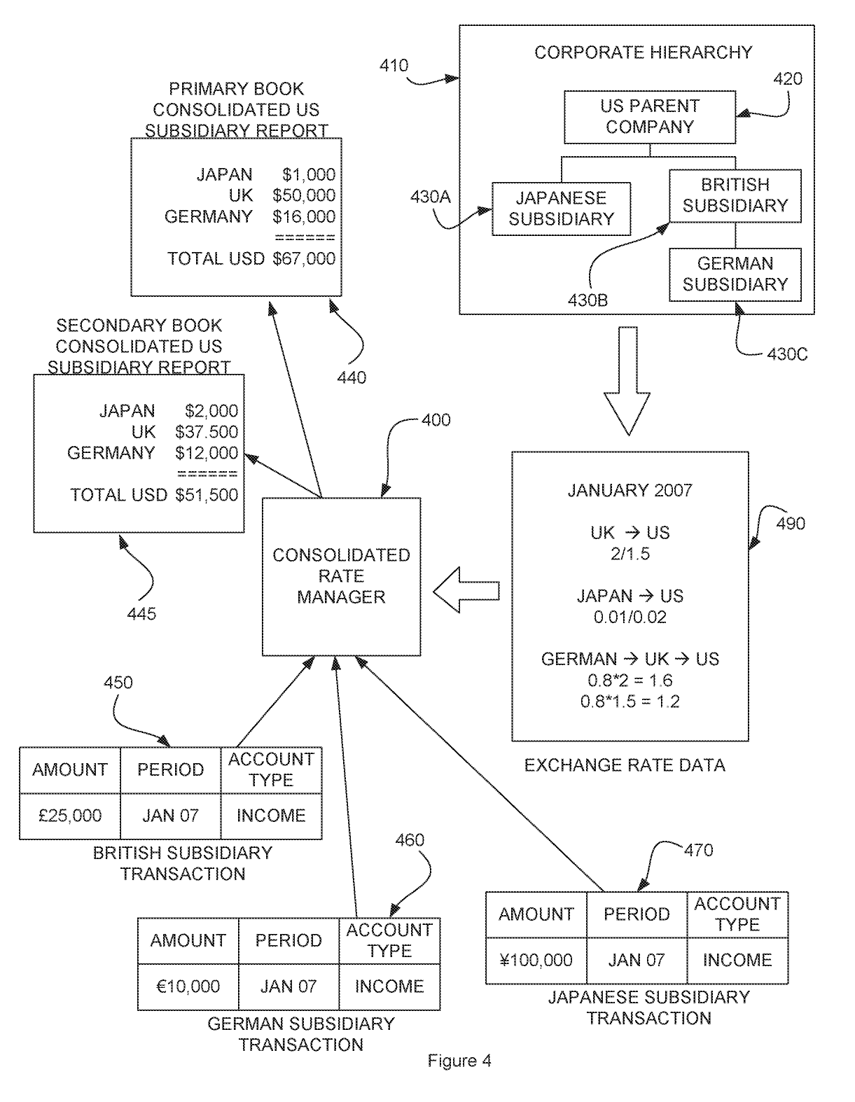

FIG. 4 is a block diagram of a system for consolidating multiple rate currencies associated with different corporate entities across more than one book (e.g., a primary book and a secondary book). The system includes an inter-subsidiary consolidated rate manager 400 that includes exchange rates to be used on a book-by-book basis and a company-by-company basis. A corporate hierarchy 410 is represented as a tree-based data structure that models a relationship of a parent company with several subsidiaries. In other words, data that describes the subsidiaries and the corresponding managing companies that are above the subsidiaries is stored in a hierarchical tree or similar data structure. For example, as shown in FIG. 4, a U.S. parent company 420 includes a Japanese subsidiary 430a and a U.K. subsidiary 430b. The U.K. subsidiary 430b further includes a German subsidiary 430c. It is noted that although a tree or similar hierarchical data structure is referred to in the description, other data structures may be used to implement embodiments without departing from the underlying concept. For example, multiple data structures may be used within the same time period, or may correspond to different time periods or different forms of data organization. In a time-based subsidiary hierarchy, a hierarchy is applicable for a specified time frame. In a version-based subsidiary hierarchy, different hierarchies may be used for the same time period.

Each subsidiary 430a, 430b, 430c enters and manages financial data in its functional currency. Thus, several different books may be kept each with a base currency. This is necessary both for functional reasons (i.e., Japanese subsidiary users do not want a functional currency of US dollars), as well as for local or regional financial reporting and tax compliance reasons. Thus, subsidiary financial reports can be generated within the context of a single subsidiary, in the functional currency of that subsidiary.

However, a subsidiary currency is not only a function of the subsidiary but also of the accounting book. Thus, e.g., a British subsidiary can use British pounds as a functional currency in a primary book and US Dollars as functional currency in secondary book. So there are two options for arriving at different consolidation rates in any secondary book: 1) subsidiaries may have the same currency in both books but the consolidated exchange rates between them can be different on per book basis, and 2) subsidiaries may have different currencies in different books hence the consolidated exchange rates are different by nature.

As an example, the U.S. parent company 420 may want to generate a consolidated U.S. subsidiary report 440 in a primary book based on a German transaction 450, a UK transaction 460 and a Japanese transaction 470. The report 440 reflects the consolidated transaction total from the perspective of the U.S. company 420. Due to the corporate hierarchy 410, the results of the individual German, Japanese and U.K. transactions 450, 460, 470 require conversion before the consolidated U.S. subsidiary report 440 can be generated. For these transactions to be provided to the parent company 420 in U.S. dollar (USD) values, each transaction completed by one of the subsidiaries is reported to the consolidated rate manager 400.

Further, the U.S. parent company 420 may want to generate a consolidated U.S. subsidiary report 445 in a secondary book using a different category of exchange rates (different categories are discussed further below) based on the same German transaction 450, UK transaction 460 and Japanese transaction 470. The report 445 reflects the consolidated transaction total from the perspective of the U.S. company 420. Again, due to the corporate hierarchy 410, the results of the individual German, Japanese and U.K. transactions 450, 460, 470 require conversion before the consolidated U.S. subsidiary report 445 can be generated. For these transactions to be provided to the parent company 420 in U.S. dollar (USD) values, each transaction completed by one of the subsidiaries is reported to the consolidated rate manager 400.

The consolidated rate manager 400 also receives, as an input, exchange rate data 490 which includes all the exchange rates between the different related subsidiaries in the corporate hierarchy 410. As shown in the figure, the conversion rate from £ to USD is 2 and the conversion rate from ¥ to USD is 0.01. However, in accordance with FASB 52 rules, the German transaction 450 is converted from [symbol] to £ and then to USD. Since the conversion rate from [symbol] to £ is 0.8, the conversion rate from [symbol] to USD is 1.6.

The consolidated rate manager 400 converts each transaction value at run time from the functional currency of the subsidiary to the functional currency of the parent company. Due to the corporate hierarchy 410, the conversion occurs through each intermediate subsidiary. For example, the consolidated rate manager 400 automatically converts the German transaction 450 from euros to U.K. pounds and then converts that value from U.K. pounds to USD, rather than converting directly from euros to USD. Based on FASB 52 rules, the consolidated transaction total from the perspective of the U.S. company 120 is $67,000.

The consolidated rate manager 400 is responsible for generating point to point (i.e., subsidiary to subsidiary) exchange rates for a given period and account type. Example account types include balance sheet, income, and equity. The account type is used to determine one of three different rate categories of consolidation rates used for converting a value to a different currency.

The rate categories correspond to how the financial data is to be represented. In accordance with FASB 52 rules, the different rate categories include ending, average, and historical. The ending rate category is an ending period spot rate used for most balance sheet accounts. The average rate category is a weighted average spot rate used for income accounts. The historical rate category is a point-in-time spot rate used for equity and some asset transactions. Thus, for every conversion between subsidiaries, three possible rate dimensions may be applicable. For example, in an income transaction, values are translated using the corresponding average rate for the applicable period, while an asset account would be translated using the ending or historical rate, depending on the nature of the asset. This is exemplified between the consolidation report 440 from the primary book and the consolidation report 445 from the secondary book in FIG. 4.

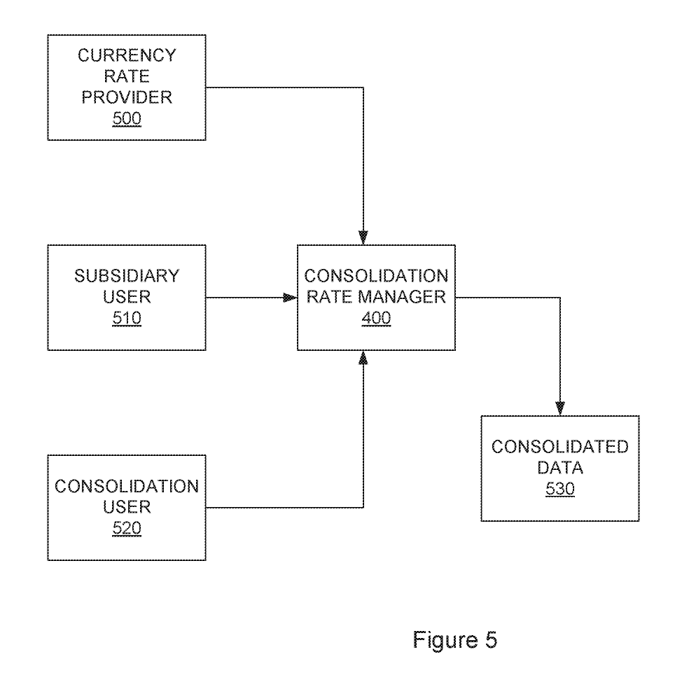

FIG. 5 is a block diagram showing a high-level view of a system for consolidating multiple rate currencies associated with different subsidiaries. The consolidated rate manager 400 acquires and aggregates currency spot rates and applies them to the functional currencies represented by the subsidiary hierarchy. At run time, the consolidated rate manager 400 supplies spot rates that are specific to the accounting period, the rate type indicated by the transaction, and the different subsidiaries that are involved in the conversion.

Referring to FIG. 5, the consolidation rate manager 400 receives three inputs. A currency rate provider 500 inputs point-to-point currency spot rates from various international exchanges in real time. In one embodiment, the currency spot rates are provided daily. A subsidiary user 510 enters financial transaction data at the local subsidiary. The subsidiary user 510 is operating in a role, for example, as an employee of the subsidiary (e.g., sales or accounting personnel) or a bookkeeper. The consolidation system is transparent to the subsidiary user 510. A consolidation user 520 (e.g., CEO, manager of a mid-level subsidiary) enters a data request for a report, a search or any other kind of aggregate financial data. The data request is received from the consolidation user 520 at a user interface. The consolidation rate manager 400 then performs the translations (i.e., roll-up) on the transactions in real-time and presents the consolidated data 530 in a unified currency to the consolidation user 520.

The subsidiary hierarchy provides the consolidation user 520 with a context in which he is working. In some embodiments, the context may provide the data that the consolidation user 520 is looking at in terms of transactional or other financial data in a particular subsidiary. The context may also provide a perspective point from which the consolidation user 520 is looking at the data relative to the other subsidiaries in the subsidiary hierarchy. For example, an administrator or bookkeeper in the parent company at the top of the subsidiary hierarchy may be looking at transactional data at three levels below in the subsidiary hierarchy. The consolidated rate manager 400 adapts to the different scenarios and automatically figures out what lies in between the data the subsidiary user 520 is looking at and where that data is to be translated by traversing the subsidiary hierarchy.

The subsidiary hierarchy is traversed by resolving the parent-child relationships between the subsidiaries that represent the tree structure of the organization. In some embodiments, the subsidiary hierarchy is traversed at run-time. In other embodiments, the subsidiary hierarchy is traversed by pre-computing values between all child nodes and the intermediate parent nodes. The subsidiary-to-subsidiary rates are then stored for subsequent retrieval. By eliminating the requirement of traversing the subsidiary hierarchy at run-time, response time is improved by requiring only a constant lookup of the different exchange rates.

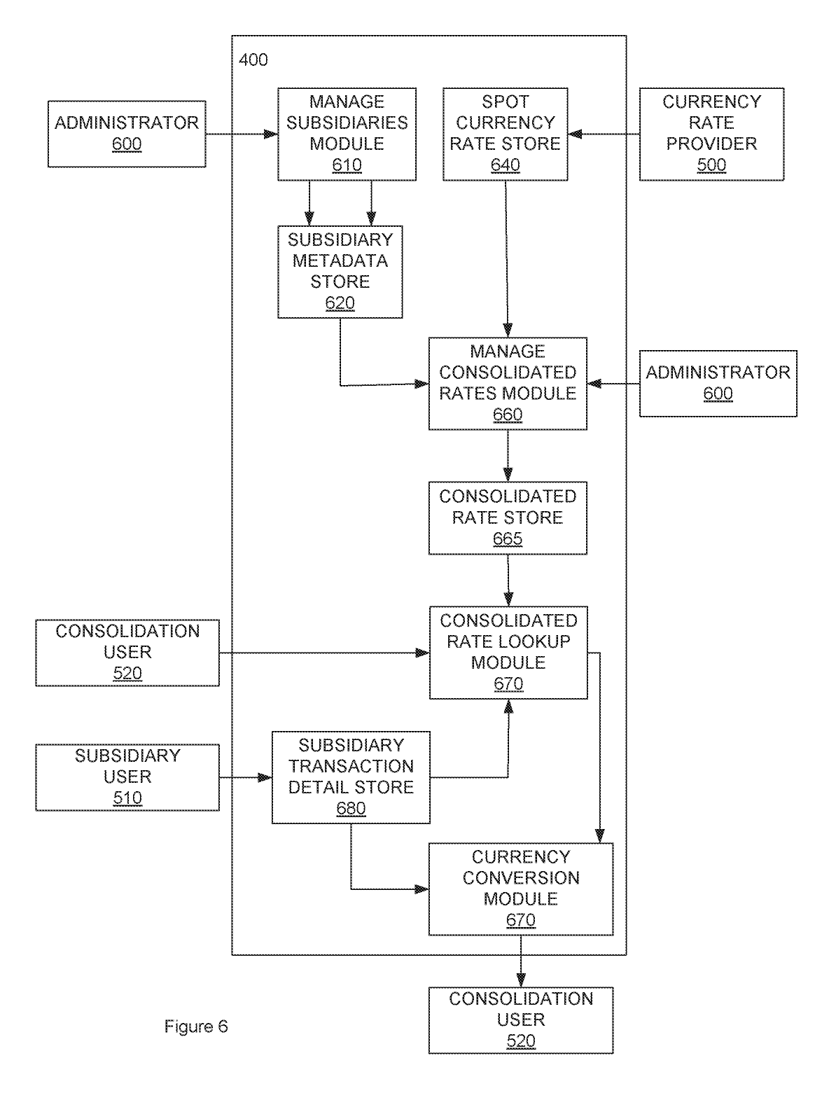

FIG. 6 is a block diagram showing a detailed view of a system 400 for consolidating multiple rate currencies associated with different subsidiaries. The figure shows modules for performing processes and independent stores of data. The consolidation system 400 may be implemented as a cached system such that much of the processing may be performed up-front or in advance to prepare data so that conversions may be performed more efficiently at run time.

An administrator 600 sets up the consolidation system using a manage subsidiaries module 610. The manage subsidiaries module 610 is a workflow that manages the metadata of the subsidiary hierarchy. The subsidiary hierarchy provides an application entry point that allows the administrator 600 to manage which subsidiaries roll up into which other subsidiaries. The subsidiary hierarchy also identifies a base currency in which each subsidiary operates. The administrator 600 may dynamically change the corporate structure by rearranging the subsidiary hierarchy. In accordance with some embodiments, the rate consolidation process is dynamically adapted in response to the changed subsidiary hierarchy. In other embodiments, the previous (i.e., unchanged) subsidiary hierarchy is preserved for a specific time period and/or may be maintained as a separate version of the subsidiary hierarchy. The subsidiary hierarchy and the base currencies for the subsidiaries are stored in a subsidiary metadata store 620.

As discussed above, the external currency rate provider 500 provides daily currency-to-currency foreign exchange rates to a spot currency rate store 640. The spot currency rate store 640 receives the exchange rates and makes any necessary conversions. For example, the spot currency rate store 640 may calculate conversion between the received exchange rates and the base currencies.

In response to input from the administrator 600, a manage consolidated rates module 660 calculates a conversion rate between different subsidiaries based on the base currency conversion rates from the spot currency rate store 640 and the subsidiary structure base currency from the subsidiary metadata store 620. The conversion rates between different subsidiaries are provided to a consolidated rate store 665.

The manage consolidated rates module 660 supports the automatic computation of the three rate categories (ending, average and historical) depending on the rate category of financial data. When automatic computation is used, each rate is calculated appropriately. That is, the ending rate is set to the spot rate for each respective accounting period's end date; the average rate is set to a weighted average calculation of the transactions posting to each respective accounting period for the applicable account types (e.g., revenue) and currencies; and the historical rate is set to the weighted average calculation of the transactions posting to each respective accounting period for the applicable account type (e.g., equity) and currencies. Using the subsidiary hierarchy, different discrete relationships between the subsidiaries are determined and stored in the consolidated rate store 665 for easy access.

The manage consolidated rates module 660 records the point-to-point rates that are possible in the subsidiary hierarchy for a given accounting period. For example, for any given month, the manage consolidated rates module 660 generates ending, average and historical rates for the U.S. to Europe, the U.S. to Germany, the U.S. to Japan and any other point where the subsidiary user 510 may request consolidated data. The manage consolidated rates module 660 calculates rates based on the subsidiary hierarchy, the base currencies of the corresponding subsidiaries, and the spot rates from the spot currency rate store 640. The manage consolidated rates module 660 then stores the results in the consolidated rate store 665. The consolidated rate store 665 provides the rates to a consolidated rate lookup module 670 at run time.

In some embodiments, the manage consolidated rates module 660 performs the calculations by traversing the subsidiary hierarchy beginning from a bottom node and working up to the entry point or the perspective point of the subsidiary user 510. To perform the calculations at run time, all possible permutations are determined for each node in the subsidiary hierarchy. For example, in a three-layer subsidiary hierarchy, calculations are performed from the third layer for all corresponding nodes. Thus, all rate-to-rate conversions are determined at each node in the subsidiary hierarchy. A factor is stored for each of the different historical, average and ending rate types. This allows for an efficient look up and data access at run time. For example, if the subsidiary user 510 is at the top of subsidiary hierarchy and is generating a consolidated balance sheet, the financial details for all the subsidiary hierarchy would be required. The process is expedited by the previously determined and stored rate-to-rate conversions because the subsidiary hierarchy need not be traversed each time a line of an invoice requires a conversion to the appropriate currency.

The subsidiary user 510 enters financial transaction information which is stored in a subsidiary transactional detail store 680. As described in detail below, local currency subsidiary budgets and forecasts may also be stored in the subsidiary transactional detail store 680 for subsequent consolidation. The consolidation user 520 requests consolidation data and the request is provided to the consolidated rate lookup module 670 at run time. The subsidiary, the accounting period, and the account type for transactions associated with the consolidated data request are provided to the consolidated rate lookup module 670.

The pertinent subsidiaries are identified using the consolidated data request. The subsidiary from which the consolidation user 520 is operating is usually implicit by the user's session. However, in cases where the user has access to multiple subsidiaries, the subsidiary context is implied by the transaction or other data that is being managed. For instance, transactional data would be “owned” by a particular subsidiary due to where the transaction would be posted or based on which customer/vendor was the entity of record. The perspective of the consolidation user 220 is determined at run time when the request for the consolidated financial data is initiated. The perspective may be a determined from the user's session (e.g., a role that is restricted to a particular subsidiary), the perspective may be implied by the particular activity (e.g., a dashboard report that displays global consolidated metrics), or the perspective may be explicit (e.g., a financial report where the subsidiary context is explicitly chosen to run the report). The other subsidiary is identified from the consolidated data request. An applicable subsidiary-to-subsidiary conversion rate is provided to the consolidated rate lookup module 670 from the consolidated rate store 665.

The consolidated data request also includes information related to the accounting period. The transactional data uses the rate that is appropriate for the corresponding accounting period. Thus, each rate corresponds to a particular accounting period (e.g., a monthly based period). The date of the transaction determines which rate to use for the conversion.

The consolidated rate lookup module 670 calculates and provides the custom spot rate to a currency conversion module 690. The custom spot rate is a customized rate used for converting a value from its initial value (i.e., a functional currency of the subsidiary) to the consolidated value (i.e., a functional currency of a parent company) at run time. The currency conversion module 690 accesses the local currency from the subsidiary transactional detail store 680 and calculates the consolidated result using the custom rate value. The consolidated result is then provided to the consolidation user 520 in response to the consolidation data request.

In some embodiments, the consolidated rate manager 400 supports forecasting and budgeting for a future accounting period (e.g., an upcoming fiscal year). The consolidation user 520 may create the forecasts for the appropriate subsidiaries with the intent to maintain a stable budget. Since actual rates fluctuate throughout the year, the consolidation user 520 does not want to use fluctuating rates when generating the budget. The consolidated rate manager 400 supports a set of budget forecast rates to handle both real time rates as well as budget rates. Thus, both budget and actual reporting may be performed throughout the year. Assumptions from the beginning of the fiscal year may be maintained to evaluate the budget based on what was projected.

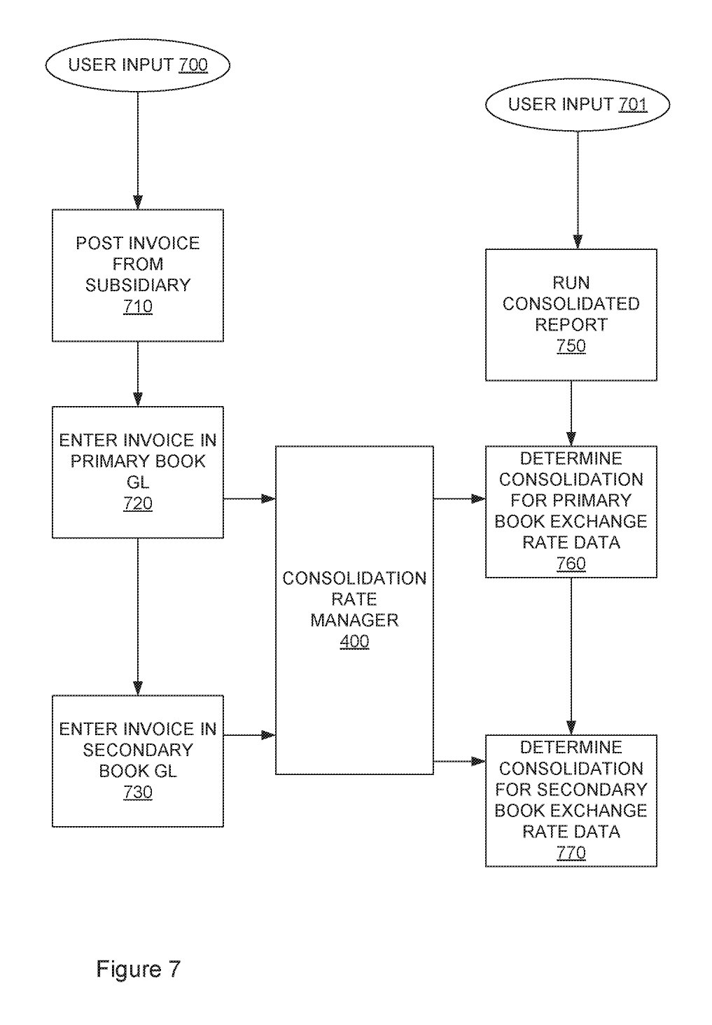

FIG. 7 is a data flow diagram showing a high level view a consolidation action across a primary book and a secondary book using different currency exchange rates according to an embodiment of the subject matter disclosed herein. In this workflow, a user input 700 may be a GL entry for a company such as an invoice from a subsidiary 710. This invoice will be entered in the primary book at 720 according to primary book GL rules and entered into the secondary book at 730 according to secondary book GL rules.

Then, when a user wishes to engage a consolidation action across the company's books, a user input 701 will trigger a run consolidation report action 750. Thus, the primary book consolidation report may invoke a currency rate exchange from the consolidation rate manager 400 that is associated with the primary book with regard to the subsidiary that results in consolidation data using the proper primary book exchange rate at 760. Likewise, the secondary book consolidation report may also invoke a currency rate exchange from the consolidation rate manager 400 that is associated with the secondary book with regard to the subsidiary that results in consolidation data using the proper secondary book exchange rate at 770.

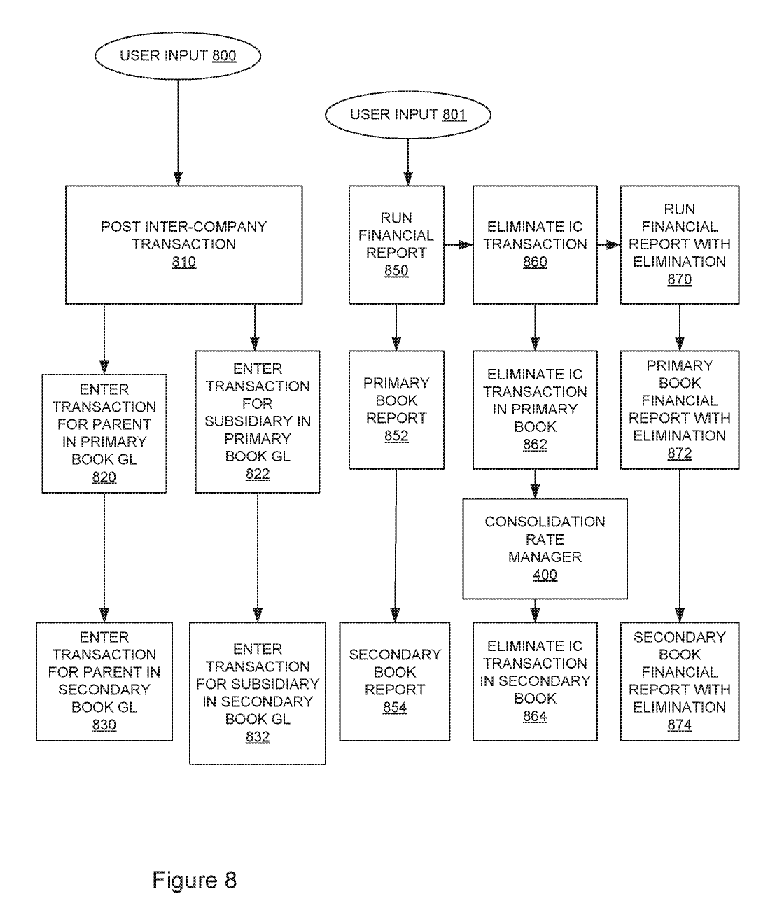

FIG. 8 is a data flow diagram showing a high level view an elimination action across a primary book and a secondary book using different currency exchange rates according to an embodiment of the subject matter disclosed herein. In this workflow, a user input 800 may be for an inter-company (IC) transaction 810 between corporate subsidiaries, in this example, a parent and a subsidiary. Thus, in a primary book, there may be two GL entries to record such an IC transaction. A first entry 820 may be in the primary book GL for the parent entity and a second entry 822 may be in the primary book GL for the subsidiary company. Similarly, a secondary book may be kept for each subsidiary. Thus, a first entry 830 may be in the secondary book GL for the parent entity and a second entry 832 may be in the secondary book GL for the subsidiary company.

In certain accounting procedures, such IC transactions may need to be removed from the books to comply with specific accounting rules. Such a procedure is called elimination and a user may trigger an elimination action via a user input 801. This process typically starts with running an initial financial report 850 for the primary book 852 and the secondary book 854. However, the IC transaction will still be present in both the primary book and the secondary book. Simply eliminating the transaction from the primary book may be acceptable, but eliminating the transaction from the secondary book may be incorrect if the secondary book is kept using a different currency. Thus, the IC transaction may be eliminated 860 in the primary book at 862, but the elimination procedure in the secondary book will utilize the exchange rate data stored in the consolidation rate manager 400 to properly eliminate the transaction in the secondary book at 864. Once the secondary book IC transaction is properly eliminated, the financial report after elimination 870 may be generated for both the primary book at 872 and the secondary book at 874.

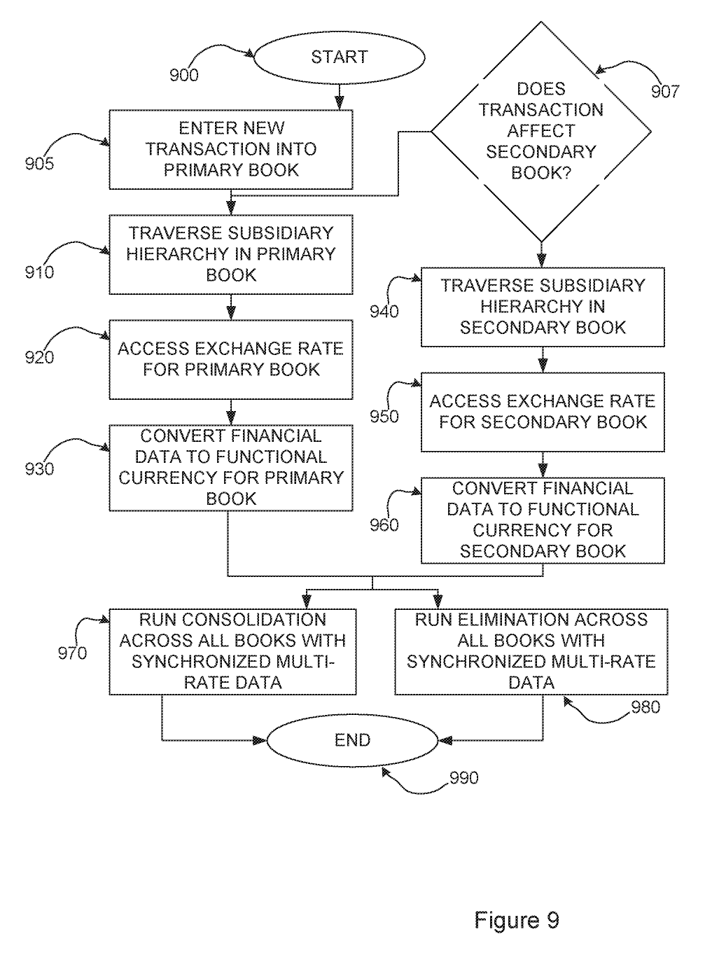

FIG. 9 is a data flow diagram illustrating a method for maintaining consistency when consolidating multiple rate currencies across multiple books in accordance with an embodiment of the subject matter disclosed herein. The method begins at a Start step 900. As shown in the diagram, a request to enter a new transaction into a primary book may be received at step 905. Such a new transaction may in turn eventually affect a number of additional bookkeeping transactions across both the primary book and the one or more secondary books via financial consolidation or elimination. Thus, as step 907. A determination is made as to whether any secondary books are affected. If so, a similar parallel process is invoked alongside the primary book steps.

In the primary book side, the new transaction may include an identifier associated with the requesting subsidiary to identify the position of the requesting subsidiary in the subsidiary hierarchy or in a different version of the subsidiary hierarchy, an accounting period for the consolidated financial data and the account type for the transactions associated with the request. The requesting subsidiary may request any type of consolidated financial data such as a report of different subsidiary transactions conducted in different currencies. The request may also be associated with a search, a budget forecast or another type of request that requires aggregation of financial data between different subsidiaries operating in different functional currencies. The different currencies associated with each transaction require conversion before the financial data may be aggregated.

A subsidiary hierarchy indicating the relationship between the different subsidiaries is traversed (step 910). The subsidiary hierarchy may be represented as a tree-based data structure indicating a relationship of a parent company with several subsidiaries positioned below the parent company in the data structure. One having skill in the art would appreciate that other data representations or data structures are possible and may be implemented in embodiments of the present invention. Each subsidiary in the subsidiary hierarchy is associated with financial data in a functional currency. For example, an American subsidiary would be associated with a currency in U.S. dollars, and a U.K. subsidiary would be associated with currency in British pounds. The requesting subsidiary is positioned higher in the hierarchy than at least one other subsidiary in the hierarchy.

In response to the request, an exchange rate between at least two related subsidiaries in the hierarchy is accessed from a data store (step 920). At least one of the related subsidiaries is the requesting subsidiary and the other one or more of the related subsidiaries are positioned below the requesting subsidiary in the subsidiary hierarchy. All the exchange rates between the different related subsidiaries in the hierarchy may be constantly updated (e.g., on a daily basis) such that the most current exchange rates are available for access. In some embodiments, the exchange rates may vary depending on, for example, the accounting period, the type of account and the rate category. In some embodiments, a second set of exchange rates between related subsidiaries is provided for requests associated with budget forecasting. Unlike the varying rates, the second set of exchange rates is static due to the nature of the requirements typical for budget forecasting. It is understood that the different applicable exchange rates for any pair of associated subsidiaries in the hierarchy are available for access.

The financial data of each subsidiary in the hierarchy is accessed and converted to the functional currency of a related subsidiary positioned higher in the hierarchy based on the corresponding exchange rate (step 930). The conversion is performed at run time through any intermediate subsidiaries in the hierarchy. For example, if one subsidiary is positioned below the parent company with two intermediate subsidiaries positioned there between and the parent company is the requesting subsidiary, the financial data would be converted three times (i.e., once at each of the two intermediate subsidiaries as well as once at the parent company.) Thus, three different conversion rates are required to convert the requested data to the functional currency of the requesting subsidiary.

If the answer to the question at step 905 is yes (e.g., a secondary book is affected by the primary transaction) then a similar process is invoked in the secondary book similar to the primary book. In short (without going into detail again), the hierarchy of the secondary book is determined and traversed at step 940, exchange rates for the secondary book are determined at step 950, and financial data in converted in the secondary book at step 960.

Any requested consolidated transaction data is calculated based on the converted transaction data for each subsidiary in the hierarchy related to and positioned lower than the requesting subsidiary (step 970) across all books, both primary and secondary. By “across all books” that is, one can run consolidation reports or intercompany elimination in any book according to one embodiment. In another embodiment, one may run consolidation report/elimination, simultaneously in two or more books. Intercompany elimination can be either run for selected accounting book only or for all books together. The consolidated financial data is calculated in the functional currency associated with the requesting subsidiary. The consolidated financial data may then be displayed to the requesting subsidiary. Similarly, any requested elimination transaction data is calculated based on the converted transaction data for each subsidiary in the hierarchy related to and positioned lower than the requesting subsidiary (step 980) across all books, both primary and secondary. The elimination financial data is calculated in the functional currency associated with the requesting subsidiary. Processing then terminates at the end step 990.

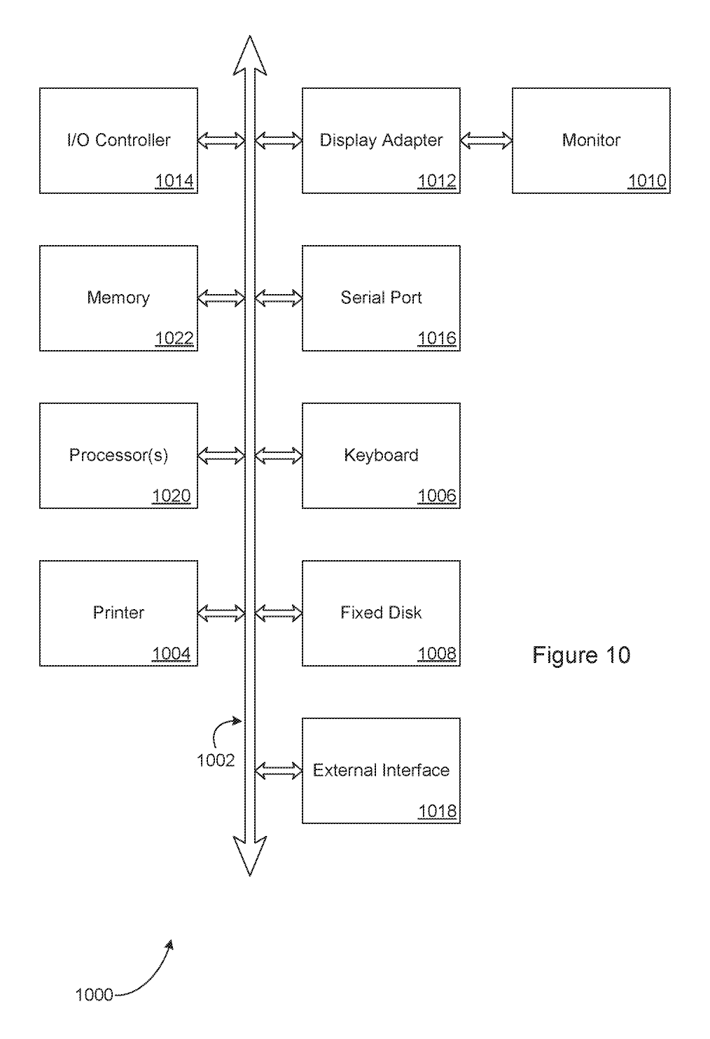

In accordance with one embodiment, the system, apparatus, methods, processes, functions, and/or operations for enabling efficient configuration and presentation of a user interface to a user based on the user's previous behavior may be wholly or partially implemented in the form of a set of instructions executed by one or more programmed computer processors such as a central processing unit (CPU) or microprocessor. Such processors may be incorporated in an apparatus, server, client or other computing or data processing device operated by, or in communication with, other components of the system. As an example, FIG. 10 is a diagram illustrating elements or components that may be present in a computer device or system 1000 configured to implement a method, process, function, or operation in accordance with an embodiment. The subsystems shown in FIG. 10 are interconnected via a system bus 1002. Additional subsystems include a printer 1004, a keyboard 1006, a fixed disk 1008, and a monitor 1010, which is coupled to a display adapter 1012. Peripherals and input/output (I/O) devices, which couple to an I/O controller 1014, can be connected to the computer system by any number of means known in the art, such as a serial port 1016. For example, the serial port 1016 or an external interface 1018 can be utilized to connect the computer device 1000 to further devices and/or systems not shown in FIG. 10 including a wide area network such as the Internet, a mouse input device, and/or a scanner. The interconnection via the system bus 1002 allows one or more processors 1020 to communicate with each subsystem and to control the execution of instructions that may be stored in a system memory 1022 and/or the fixed disk 1008, as well as the exchange of information between subsystems. The system memory 1022 and/or the fixed disk 1008 may embody a tangible computer-readable medium.

It should be understood that the present disclosures as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, Java, Javascript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

What is claimed is:

1. A computer-implemented method, comprising:
receiving a request to alter financial data, wherein the request is received at a user interface, the request indicating a financial alteration with respect to a subsidiary relative to one or more different subsidiaries;
traversing a data structure representing a subsidiary hierarchy of the subsidiary and the one or more subsidiaries indicating a relationship between the different corporate subsidiaries to identify a relationship, wherein each subsidiary in the subsidiary hierarchy comprises financial data in a functional currency;
in response to the request, accessing, from a data store, a first exchange rate between at least two related subsidiaries in the subsidiary hierarchy, the first exchange rate corresponding to a primary accounting book and corresponding to the identified relationship;
in response to the request, accessing, from a data store, a second exchange rate between the at least two related subsidiaries in the subsidiary hierarchy, the second exchange rate corresponding to a secondary accounting book and corresponding to the identified relationship;
converting the altered financial data in the primary book in accordance with the first exchange rate; and
converting the altered financial data in the secondary book in accordance with the second exchange rate.

2. The method of claim 1, wherein the subsidiary hierarchy is a tree-based data structure, each corporate subsidiary in the subsidiary hierarchy corresponding to a node in the tree-based data structure.

3. The method of claim 1, further comprising:
receiving exchange rate data for converting a functional currency of one subsidiary in the subsidiary hierarchy to a different functional currency of any other subsidiary in the subsidiary hierarchy; and
storing the received exchange rate data in the data store.

4. The method of claim 1, wherein the exchange rate data comprises different rate categories.

5. The method of claim 4, wherein the different rate categories are associated with different accounting periods.

6. The method of claim 4, wherein the different rate categories are associated with different account types.

7. The method of claim 1, further comprising:
displaying the consolidated financial data to user interface of the requesting subsidiary.

8. The method of claim 1, wherein the subsidiary hierarchy identifies the functional currency of each subsidiary in the subsidiary hierarchy.

9. The method of claim 1, further comprising:
receiving a request to eliminate an inter-company transaction between subsidiaries, wherein the request is received at a user interface, the request indicating a financial transaction to be eliminated with respect to a subsidiary relative to one or more different subsidiaries;
traversing a data structure representing a subsidiary hierarchy of the subsidiary and the other subsidiaries indicating a relationship between the different corporate subsidiaries to identify a relationship, wherein each subsidiary in the subsidiary hierarchy comprises financial data in a functional currency;
in response to the request, accessing, from a data store, a first exchange rate between at least two related subsidiaries in the subsidiary hierarchy, the first exchange rate corresponding to a primary accounting book and corresponding to the identified relationship;
in response to the request, accessing, from a data store, a second exchange rate between the at least two related subsidiaries in the subsidiary hierarchy corresponding to a primary accounting book and corresponding to the identified relationship;
eliminating the transaction in the primary book in accordance with the first exchange rate; and
eliminating the transaction in the secondary book in accordance with the second exchange rate.

10. A multi-tenant computing platform, comprising:
one or more server computers configured to host one or more tenants, each tenant having access to executable instructions for respectively maintaining a plurality of accounting books for a plurality of tenant-owned related corporate entities;
a primary accounting book module configured to facilitate recording of accounting transaction data in a first currency according to primary accounting book rules;
a secondary accounting book module configured to facilitate recording of accounting transaction data in a second currency according to secondary accounting book rules;
a hierarchy module configured to host a data structure indicating a hierarchy of the tenant-owned related corporate entities and a respective currency for transactions;
a consolidated exchange rate module configured to:
receive a request to alter financial data, wherein the request is received at a user interface, the request indicating a financial alteration with respect to a subsidiary relative to one or more different related tenant-owned corporate entities;
in response to the request, accessing, from a data store, a first exchange rate for the subsidiary relative to the one or more different related tenant-owned corporate entities, the first exchange rate corresponding to the primary accounting book module and corresponding to the identified relationship;
in response to the request, accessing, from a data store, a second exchange rate for the subsidiary relative to the one or more different related tenant-owned corporate entities, the second exchange rate corresponding to the secondary accounting book module and corresponding to the identified relationship;
converting the altered financial data in the primary book module in accordance with the first exchange rate; and
converting the altered financial data in the secondary book module in accordance with the second exchange rate.

11. The system of claim 10, wherein the subsidiary hierarchy is a tree-based data structure, each corporate subsidiary in the corporate entity hierarchy corresponding to a node in the tree-based data structure.

12. The system of claim 10, further comprising:
a spot currency rate store configured to store exchange rate data for converting a functional currency of one subsidiary in the subsidiary hierarchy to a different functional currency of any other subsidiary in the corporate entity hierarchy.

13. The system of claim 10, wherein the consolidated exchange rate module is further configured to calculate a conversion rate between each pair of different entities in the corporate entity hierarchy using the exchange rate data and the functional currency associated with each entity in the corporate entity hierarchy.

14. The system of claim 10, further comprising a module configured to display the consolidated financial data to the user interface of the requestor.

15. The system of claim 10, further comprising:
a manage entities module for modifying the corporate entity hierarchy in response to user input, wherein the manage entities module stores an unmodified version of the corporate entity hierarchy.

16. The system of claim 10, wherein the exchange rate data comprises an exchange rate from the group comprised of: ending rate, average rate, and historical rate.

17. The system of claim 10, further comprising an update module configured to update the exchange rate data at regular intervals.

18. The system of claim 10, further comprising:
an elimination module having computer-executable instructions for:
receiving a request to eliminate an inter-company transaction between subsidiaries, wherein the request is received at a user interface, the request indicating a financial transaction to be eliminated with respect to a subsidiary relative to one or more different subsidiaries;
traversing a data structure representing a subsidiary hierarchy of the subsidiary and the other subsidiaries indicating a relationship between the different corporate subsidiaries to identify a relationship, wherein each subsidiary in the subsidiary hierarchy comprises financial data in a functional currency;
in response to the request, accessing, from a data store, a first exchange rate between at least two related subsidiaries in the subsidiary hierarchy, the first exchange rate corresponding to a primary accounting book and corresponding to the identified relationship;
in response to the request, accessing, from a data store, a second exchange rate between the at least two related subsidiaries in the subsidiary hierarchy corresponding to a primary accounting book and corresponding to the identified relationship;
eliminating the transaction in the primary book in accordance with the first exchange rate; and
eliminating the transaction in the secondary book in accordance with the second exchange rate.

19. A computer-implemented method, comprising:
receiving a request to eliminate an inter-company transaction between a first subsidiary and a second related subsidiary, wherein the request is received at a user interface, the request indicating a financial transaction to be eliminated with respect to a subsidiary relative to one or more different subsidiaries;
traversing a data structure representing a subsidiary hierarchy of the subsidiary and the other subsidiaries indicating a relationship between the different corporate subsidiaries to identify a relationship, wherein each subsidiary in the subsidiary hierarchy comprises financial data in a functional currency;
in response to the request, accessing, from a data store, a first exchange rate between at least two related subsidiaries in the subsidiary hierarchy, the first exchange rate corresponding to a primary accounting book and corresponding to the identified relationship;
in response to the request, accessing, from a data store, a second exchange rate between the at least two related subsidiaries in the subsidiary hierarchy corresponding to a primary accounting book and corresponding to the identified relationship;
eliminating the transaction in the primary book in accordance with the first exchange rate; and
eliminating the transaction in the secondary book in accordance with the second exchange rate.
